(19) United States
(12) Patent Application Publication
(10) Pub. No.: US 2015/0246560 A1
(43) Pub. Date: Sep. 3, 2015

(54) RECORDING MATERIAL DISCHARGE DEVICE AND RECORDING MATERIAL PROCESSING DEVICE USING THE SAME

(71) Applicant: FUJI XEROX CO., LTD., Tokyo (JP)

(72) Inventors: Shinya NAKAMURA, Kanagawa (JP); Kazutoshi SHIMA, Kanagawa (JP); Hiroshi KAWAMOTO, Kanagawa (JP); Hiroyuki TAMAI, Kanagawa (JP); Mizuki ARAI, Kanagawa (JP)

(73) Assignee: FUJI XEROX CO., LTD., Tokyo (JP)

(21) Appl. No.: 14/612,967

(22) Filed: Feb. 3, 2015

(30) Foreign Application Priority Data
Feb. 28, 2014 (JP) 2014-038882

(51) Int. Cl. B41J 11/58; B65H 31/00; B65H 43/00; B65H 29/68

(52) U.S. Cl. CPC B41J 11/58; B65H 29/68; B65H 31/00; B65H 43/00

(57) ABSTRACT

Provided is a recording material discharge device including a recording material discharge member that discharges recording materials, and a recording material accommodating unit that accommodates the plural recording materials which are discharged from the recording material discharge member, wherein a discharge velocity of a first recording material discharged by the recording material discharge member is lower than a discharge velocity of each of second and subsequent recording materials.

### CROSS-REFERENCE TO RELATED APPLICATIONS

This application is based on and claims priority under 35 USC 119 from Japanese Patent Application No. 2014-038882 filed Feb. 28, 2014.

### BACKGROUND

### Technical Field

The present invention relates to a recording material discharge device that is used for, for example, a recording material processing device, such as a copying machine or a printer, and, in particular, to a recording material discharge device that is capable of aligning (adjusting) recording materials, which are discharged from the recording material discharge device to a recording material accommodating unit, and a recording material processing device using the recording material discharge device.

### SUMMARY

According to an aspect of the invention, there is provided a recording material discharge device including:

a recording material discharge member that discharges recording materials; and

a recording material accommodating unit that accommodates the plural recording materials which are discharged from the recording material discharge member,

wherein a discharge velocity of a first recording material discharged by the recording material discharge member is lower than a discharge velocity of each of second and subsequent recording materials.

### BRIEF DESCRIPTION OF THE DRAWINGS

Exemplary embodiments of the present invention will be described in detail based on the following figures, wherein:

FIG. 1 is an explanatory diagram illustrating an outline of an exemplary embodiment of a recording material discharge device to which the present invention is applied;

FIG. 2 is an explanatory diagram illustrating an outline of another exemplary embodiment of the recording material discharge device to which the present invention is applied in FIG. 1;

FIG. 3 is a front view illustrating the whole configuration of an image forming device which is an example of a recording material processing device according to a first exemplary embodiment;

FIG. 4 is an explanatory diagram illustrating an image forming unit according to the first exemplary embodiment;

FIGS. 5A and 5B are views illustrating the vicinity of a discharge roll in the image forming device according to the first exemplary embodiment, FIG. 5A is a perspective diagram viewed from the side of an upper accommodating tray, and FIG. 5B is a schematic block diagram illustrating a configuration in which the discharge roll discharges a recording material;

FIG. 6 is an enlarged diagram of FIG. 5A;

FIG. 7 is a perspective diagram illustrating the left side of the image forming device according to the first exemplary embodiment;

FIG. 8 is a perspective diagram illustrating the discharge roll according to the first exemplary embodiment;

FIG. 9 is a schematic cross-sectional diagram illustrating the vicinity of an accommodating tray viewed from the front and is a diagram illustrating a situation in which a first recording material is discharged;

FIG. 10 is a schematic cross-sectional diagram illustrating the vicinity of the accommodating tray viewed from the front and is a diagram illustrating a situation in which second and subsequent recording materials are discharged;

FIG. 11 is a flowchart illustrating a first aspect of control performed by a control device;

FIG. 12 is a flowchart illustrating a second aspect of control performed by the control device;

FIG. 13 is a schematic block diagram illustrating a configuration in which a discharge roll discharges a recording material in an image forming device according to a second exemplary embodiment;

FIGS. 14A to 14C are views illustrating an example of a recording material presence detector, FIG. 14A is a front view in which the vicinity of an accommodating tray is viewed from the front of FIG. 3, FIG. 14B is a plan view in which the accommodating tray of FIG. 14A is viewed from the upper side, and FIG. 14C is a schematic diagram illustrating an example of the configuration of the recording material presence detector;

FIG. 15 is a flowchart illustrating a third aspect of control performed by the control device; and

FIG. 16 is a flowchart illustrating a fourth aspect of control performed by the control device.

### DETAILED DESCRIPTION

### Outline of Exemplary Embodiment

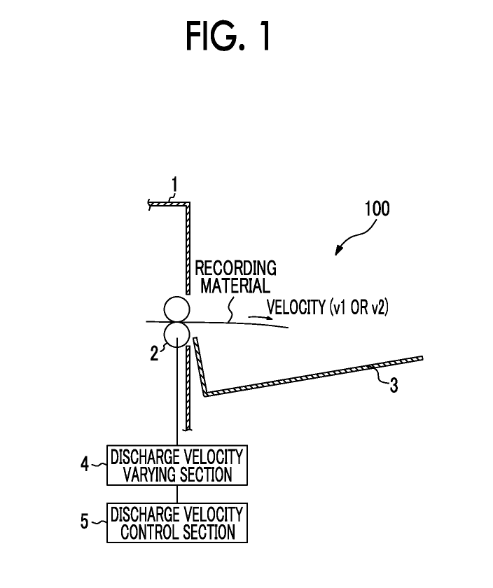

FIG. 1 is an explanatory diagram illustrating an outline of an exemplary embodiment of a recording material discharge device to which the present invention is applied.

In the drawing, a recording material discharge device 100 according to the exemplary embodiment is a recording material discharge device 100 that is provided in a processing device main body 1, and that discharges and accommodates recording materials which are processed by a processing unit in the processing device main body 1. The recording material discharge device 100 includes a recording material discharge member 2 that discharges the recording materials from the processing device main body 1, a recording material accommodating unit 3 that accommodates the plural recording materials which are discharged from the recording material discharge member 2, a discharge velocity varying section 4 that changes the discharge velocity v of each of the recording materials discharged by the recording material discharge member 2, and a discharge velocity control section 5 that performs control such that the recording materials are discharged at a predetermined velocity v1 using the discharge velocity varying section 4 when second and subsequent recording materials are discharged, and that the recording materials are discharged at a velocity v2 which is lower than the velocity v1 using the discharge velocity varying section 4 when a first recording material is discharged.

As the processing device, an image forming device, such as a copying machine or a printer, which forms images on the recording materials may be used, or a post-processing device, such as a sorter device which performs a sorting process on the recording materials or a stapling device which performs a stapling process on the recording materials, may be used.

With regard to an image forming method of an image forming unit, used when the processing device is the image forming device, it is apparent that a method of forming a latent image on a photoreceptor and developing the latent image, transferring and fixing the developed latent image on the recording materials (for example, an electro-photographic method, electrostatic recording method using ion currents, or the like) may be used. However, the present invention is not limited thereto. Although any one of a heat sensitive method, a thermal transfer method, and an ink jet method, in which thermal paper is used as the recording materials, may be used, the present invention is suitable for a case in which the recording materials are discharged at a high speed.

The recording material discharge member 2 induces the recording materials to a discharge port which is provided on the side of the processing device, and discharges the recording materials from the discharge port. The recording material discharge member 2 includes, for example, a discharge roll, and transports and discharges the recording materials which are inserted into the discharge roll in such a way that the roll rotates.

The recording material accommodating unit 3 loads and accommodates the plural recording materials. The recording material accommodating unit 3 has, for example, a saucer shape, and is provided on the outside of the processing device main body 1 and under the discharge port. The recording materials are discharged to the side from the discharge port, fall onto the recording material accommodating unit 3, and are then accommodated.

The discharge velocity varying section 4 is, for example, a drive motor that rotates the discharge roll which is the recording material discharge member 2, and may change the discharge velocity v of each of the recording materials by changing the rotation velocity of the drive motor.

The discharge velocity control section 5 is, for example, a control section such as a CPU, controls the discharge velocity varying section 4, and selects one of at least two types of velocities of a case in which the recording materials are discharged at the velocity v1 and a case in which the recording materials are discharged at the velocity v2. A case, in which a process (for example, an image forming process or a post-processing) is performed on the recording materials and the recording materials are discharged, is assumed. When plural recording materials is discharged and the first recording material is discharged, the discharged recording material directly comes into contact with the recording material accommodating unit 3. When the second and subsequent recording materials are discharged, the recording materials come into contact with the recording material which is discharged immediately before. Therefore, based on the difference in the coefficients of friction between the recording material and the recording material accommodating unit 3, there is a case in which deviation of an accommodating tray to the recording material accommodating unit 3 may occur between the first piece and the second and subsequent pieces. For example, since the recording material accommodating unit 3 has the smaller coefficient of friction than the recording materials, a slide distance is large when the discharge velocity v is high, and thus the accommodating tray is deviated. Here, when the first recording material is discharged, the discharge velocity control section 5 performs control such that the recording material is discharged at the velocity v2 which is lower than the velocity v1 acquired when the second and subsequent recording materials are discharged.

### Outline of Another Exemplary Embodiment

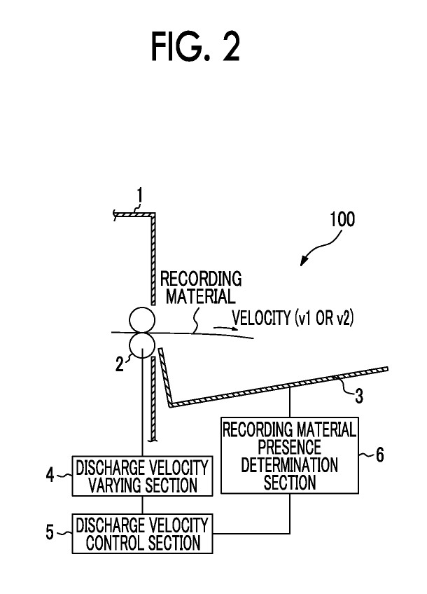

FIG. 2 illustrates an outline of another exemplary embodiment of the recording material discharge device to which the present invention is applied in FIG. 1.

In the drawing, the recording material discharge device 100 according to the exemplary embodiment is the recording material discharge device 100 that is provided in the processing device main body 1, and that discharges and accommodates recording materials which are processed by a processing unit in the processing device main body 1. The recording material discharge device 100 includes the recording material discharge member 2 that discharges the recording materials from the processing device main body 1, the recording material accommodating unit 3 that accommodates the plural recording materials which are discharged from the recording material discharge member 2, the discharge velocity varying section 4 that changes the discharge velocity v of each of the recording materials discharged by the recording material discharge member 2, a recording material presence determination section 6 that determines the presence of the recording materials which are accommodated in the recording material accommodating unit 3, and the discharge velocity control section 5 that performs control such that the recording materials are discharged at a velocity v1 which is predetermined by the discharge velocity varying section 4 when it is determined that there are the recording materials which are accommodated in the recording material accommodating unit 3 by the recording material presence determination section 6, and such that the recording materials are discharged at a velocity v2 which is lower than the velocity v1 using the discharge velocity varying section 4 when it is determined that there are no recording materials which are accommodated in the recording material accommodating unit 3.

As the processing device, an image forming device, such as a copying machine or a printer, which forms images on the recording materials may be used, or a post-processing device, such as a sorter device which performs a sorting process on the recording materials or a stapling device which performs a stapling process on the recording materials, may be used.

With regard to an image forming method of an image forming unit, used when the processing device is the image forming device, it is apparent that a method of forming a latent image on a photoreceptor and developing the latent image, transferring and fixing the developed latent image on the recording materials (for example, an electro-photographic method, electrostatic recording method using ion currents, or the like) may be used. However, the present invention is not limited thereto. Although any one of a heat sensitive method, a thermal transfer method, and an ink jet method, in which thermal paper is used as the recording materials, may be used, the present invention is suitable for a case in which the recording materials are discharged at a high speed.

The recording material discharge member 2 induces the recording materials to a discharge port which is provided on the side of the processing device, and discharges the recording materials from the discharge port. The recording material discharge member 2 includes, for example, a discharge roll, and transports and discharges the recording materials which are inserted into the discharge roll in such a way that the roll rotates.

The recording material accommodating unit 3 loads and accommodates the plural recording materials. The recording material accommodating unit 3 has, for example, a saucer shape, and is provided on the outside of the processing device main body 1 and under the discharge port. The recording materials are discharged to the side from the discharge port, fall onto the recording material accommodating unit 3, and are then accommodated.

The discharge velocity varying section 4 is, for example, a drive motor that rotates the discharge roll which is the recording material discharge member 2, and may change the discharge velocity v of each of the recording materials by changing the rotation velocity of the drive motor.

The recording material presence determination section 6 determines, for example, the presence of the recording materials which are accommodated in the recording material accommodating unit 3 using optical sensors.

The discharge velocity control section 5 is, for example, a control section such as a CPU, controls the discharge velocity varying section 4, and selects one of at least two types of velocities of a case in which the recording materials are discharged at the velocity v1 and a case in which the recording materials are discharged at the velocity v2. A case, in which a process (for example, an image forming process or a post-processing) is performed on the recording materials and the recording materials are discharged, is assumed. When there is no recording material which is accommodated in the recording material accommodating unit 3, the discharged recording material directly comes into contact with the recording material accommodating unit 3. When there is a recording material which is accommodated in the recording material accommodating unit 3, the recording material comes into contact with the recording material which is discharged immediately before. Therefore, based on the difference in the coefficients of friction between the recording material and the recording material accommodating unit 3, there is a case in which deviation of an accommodating tray to the recording material accommodating unit 3 may occur in a case in which the recording materials are accommodated in the recording material accommodating unit 3 and a case in which the recording materials are not accommodated in the recording material accommodating unit 3. For example, since the recording material accommodating unit 3 has the smaller coefficient of friction than the recording materials, a slide distance is large when the discharge velocity v is high, and thus the accommodating tray is deviated. Here, when the recording materials are not accommodated in the recording material accommodating unit 3, the discharge velocity control section 5 performs control such that the recording materials are discharged at the velocity v2 which is lower than the velocity v1 acquired when the recording materials are accommodated in the recording material accommodating unit 3.

### Outline of Representative Aspect or Preferable Aspect Of Exemplary Embodiment

Subsequently, a representative aspect or a preferable aspect of a fixing device according to the exemplary embodiment will be described.

First, as a preferable aspect of the velocity v1 and the velocity v2, an aspect in which the velocity v1 is equal to or higher than 180 mm/sec (for example, 250 to 300 mm/sec) and the velocity v2 is lower than 180 mm/sec may be provided.

When the velocity v1 is equal to or higher than 180 mm/sec (for example, 250 to 300 mm/sec) and the velocity v1 is caused to be equal to the velocity v2, remarkable deviation in the recording materials occurs. However, when the velocity v2 is caused to be lower than the velocity v1, it is possible to suppress the deviation in the recording materials.

In addition, as preferable aspects of the recording material discharge member 2 and the discharge velocity varying section 4, an aspect, in which the recording material discharge member 2 is a discharge roll that discharges the recording materials, the discharge velocity varying section 4 is a drive motor that drives the discharge roll, and the discharge velocity control section 5 drives the drive motor and controls the discharge velocity v of each of the recording materials by controlling the rotation velocity of the drive motor, may be provided.

The recording material discharge member 2 is, for example, a set of rotation members in which the recording materials are interposed and transported. The recording material discharge member 2 is, for example, a set of discharge rolls. The recording materials which are inserted between the discharge rolls are transported and discharged in such a way that the rolls rotate.

The discharge velocity varying section 4 is, for example, a drive source that rotates the discharge rolls which are the recording material discharge member 2. The discharge velocity varying section 4 is, for example, a drive motor and may change the discharge velocity v of the recording material by changing the rotation velocity of the drive motor.

In addition, as a preferable aspect of the discharge velocity control section 5 which includes the detection section, an aspect, provided with a detection section which detects a timing immediately before the rear end position of the recording material slips out from the recording material discharge member 2, may be provided.

The detection section detects the rear end position of the recording material which passes through, for example, the discharge rolls, and acquires the timing at which the recording material slips out from the discharge rolls. The discharge velocity control section 5 controls the rotation velocity of the drive motor immediately before the recording material slips out from the discharge rolls, and sets the discharge velocity v of the recording material to the velocity v1 or the velocity v2.

In addition, as an aspect in which the recording material discharge device 100 is applied to the recording material processing device, an aspect, provided with a processing unit which is provided in the processing device main body 1 and processes the recording material and the recording material discharge device 100, may be provided.

Hereinafter, the present invention will be described in further detail according to exemplary embodiments illustrated in the accompanying drawings.

### First Exemplary Embodiment

### Whole Configuration

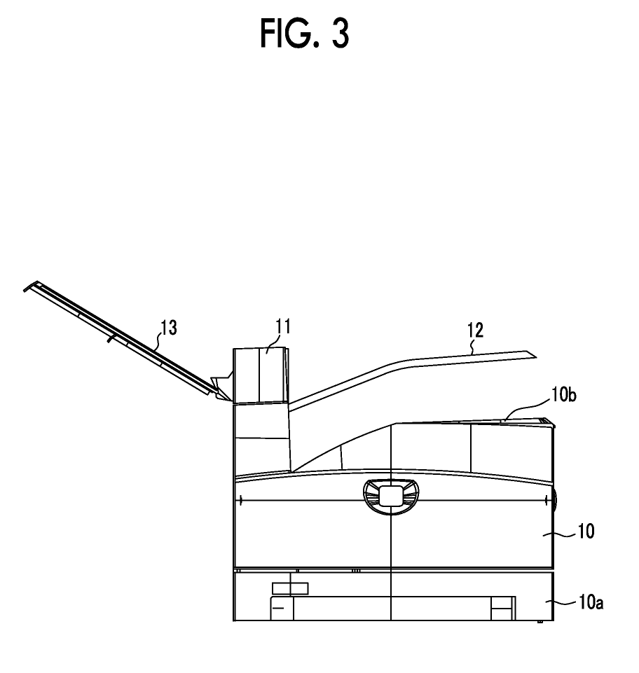

FIG. 3 is an outline view illustrating the whole configuration of an image forming device according to a first exemplary embodiment.

In the drawing, the image forming device as a recording material processing device according to the exemplary embodiment includes a main body unit 10, that mainly forms an image, as the processing device main body 1, a recording material supply unit 10a that is provided under the main body unit 10 and supplies recording materials, and a branching transport device 11 that is attached on the upper side of the main body unit 10 as an optional device and causes the recording materials, on which image formation is completed, to branch. Also, in the branching transport device 11, accommodating trays 12 and 13 are provided as two recording material accommodating units 3 in both the right and left directions of the drawing. Therefore, in the image forming device according to the exemplary embodiment, the recording materials, which are supplied from the recording material supply unit 10a, branch at three places, that is, an accommodating tray 10b as the recording material accommodating unit 3, which is provided in the main body unit 10, and the accommodating trays 12 and 13, which pass through the branching transport device 11, and then are discharged.

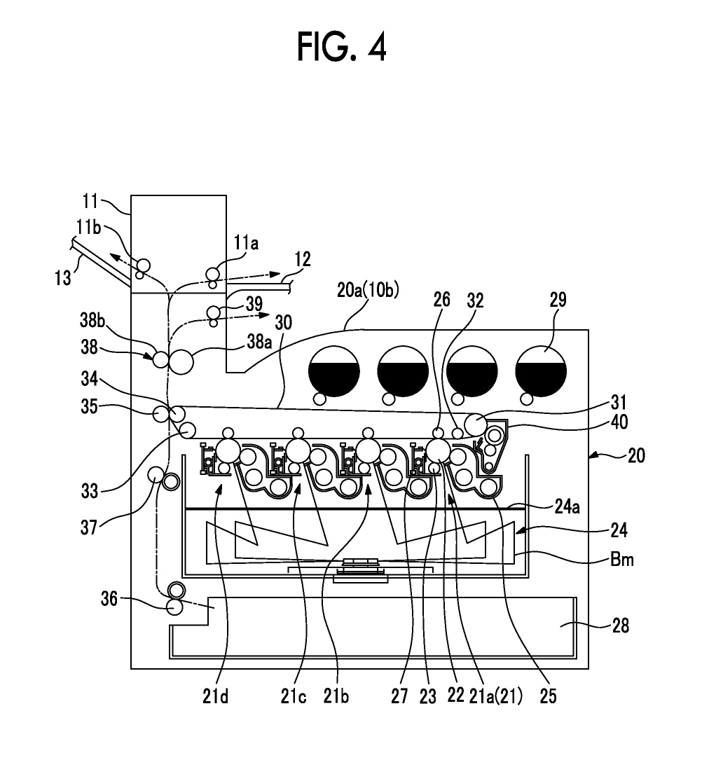

Subsequently, the inner configuration of the image forming device according to the exemplary embodiment will be described. FIG. 4 illustrates the inner configuration, and the main body unit 10 and the recording material supply unit 10a are accommodated in the same device main body 20.

In the drawing, in the image forming device according to the exemplary embodiment, 4-color (in this example, yellow, magenta, cyan, and black) image forming units 21 (21a to 21d) are arranged in the horizontal direction in the device main body 20, an intermediate transfer belt 30, which is circulated and transported along the arrangement direction of each of the image forming units 21, is arranged on the upper side of the image forming units 21, and a recording material transport path from a recording material supply cassette 28, which is arranged on the lower side of the device main body 20, is arranged in the approximately vertical direction.

Each of the image forming units 21 (21a to 21d) forms a toner image for yellow, magenta, cyan, or black (the arrangement is not necessarily limited to this order) from the upstream side in the circulation direction of the intermediate transfer belt 30, and includes a photoreceptor 22 in which a photosensitive layer, such as an organic photosensitive material, is formed on a surface, a charging unit 23 which is arranged around the photoreceptor 22 and charges the photoreceptor 22, an exposure unit 24 which writes a latent image on the charged photoreceptor 22, a development unit 25 which develops the latent image on the photoreceptor 22 and forms a toner image, a primary transfer unit 26 which is provided in a position facing the photoreceptor 22 while interposing the intermediate transfer belt 30 therebetween and which transfers the toner image on the photoreceptor 22 to the intermediate transfer belt 30, and a cleaner 27 which cleans remaining toner on the photoreceptor 22. Also, reference numeral 29 in the drawing indicates a toner cartridge for supplying toner to the development unit 25 of each of the image forming units 21, a toner supply path, which is not shown in the drawing, is provided between the reference numeral 29 and each corresponding development unit 25, and thus toner is appropriately supplied from the toner cartridge 29 to the development unit 25.

In addition, in the exemplary embodiment, the single exposure unit 24 which is common to the 4-color image forming units 21 (21a to 21d) is provided as the exposure unit 24. The exposure unit 24 stores, for example, a semiconductor laser, a polygon mirror, a lens, a mirror, and the like, in a casing 24a, irradiates the photoreceptor 22 with light beams Bm for the respective color components, and causes an image to be formed at an exposure point.

Further, the intermediate transfer belt 30 according to the exemplary embodiment is disposed on plural stretching rolls 31 to 34, and circulates and moves, for example, the stretching roll 31 as the drive roll. In addition, in a position opposite to the stretching rolls 34 of the intermediate transfer belt 30, a secondary transfer unit 35 is arranged that collectively transfers the toner images, which are primarily transferred from the respective image forming units 21 and then multiplexed on the intermediate transfer belt 30, onto the recording material which is supplied from the recording material supply cassette 28 while using the stretching rolls 34 as a backup roll.

Further, a belt cleaner 40 which cleans remaining toner on the intermediate transfer belt 30 is provided to face the stretching roll 31.

In addition, in the exemplary embodiment, in the vicinity of the downstream side of the recording material supply cassette 28, a set of feed roll and retard roll 36, which handle one piece of recording material and transport the recording material along the recording material transport path, are provided. Therefore, one piece of recording material, which is picked up from the recording material supply cassette 28 by a pick-up roll which is not shown in the drawing, is transported along the recording material transport path.

Further, a resist roll 37 which performs recording material positioning and transports the recording material to the side of a secondary transfer part (the installation part of the secondary transfer unit 35) at a predetermined timing, is arranged on the recording material transport path (path which is shown by a dashed line in the drawing), and a fixing unit 38, which fixes toner images collectively transferred to the recording material, is provided on the downstream side of the secondary transfer unit 35. Excellent fixing is performed by, for example, heating nips of a heating roll 38a and a pressure roll 38b.

Further, the recording material, on which the toner images are fixed, is discharged by a discharge roll 39 as the recording material discharge member to an accommodating tray 20a as a recording material accommodating member which is formed at a part of the device main body 20.

Further, in the exemplary embodiment, the branching transport device 11 is attached to the upper part of the device main body 20, and the recording material, which passed through the fixing unit 38 on the side of the device main body 20, is discharged to each of two accommodating trays 12 and 13 by two discharge rolls 11a and 11b. The accommodating tray 12 of the accommodating trays 12 and 13 is provided on the upper side of the accommodating tray 20a (10b) on the side of the device main body 20. Also, a switching unit or a recording material transport member is provided on the recording material transport path such that the recording material, which passed through the fixing unit 38, is appropriately discharged to three accommodating trays 20a, 12, and 13.

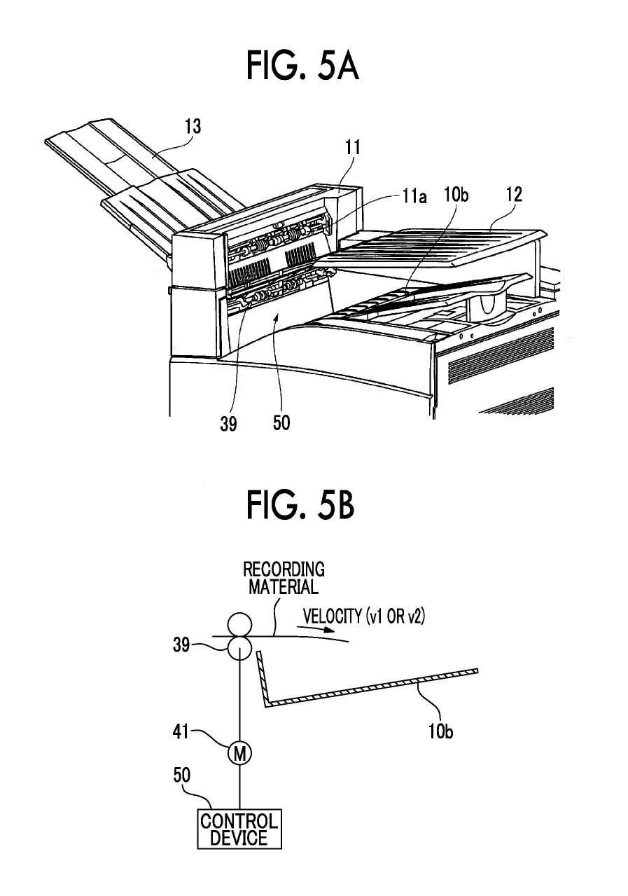

FIGS. 5A and 5B are views illustrating the vicinity of the discharge roll 39 in the image forming device according to the exemplary embodiment. FIG. 5A is a perspective diagram viewed from the side of the upper accommodating tray 12, and FIG. 5B is a schematic block diagram illustrating a configuration in which the discharge roll 39 discharges the recording material.

With reference to FIG. 5A, discharge rolls 11a and 39, which discharge the recording material to the upper accommodating tray 12 and the lower accommodating tray 10b, are recognized. The discharge rolls 11a and 39 have a shape in which a part of a lower side roll projects to the upper side roll in order to excellently discharge the recording material, thereby applying a corrugation effect to the discharged recording material. Also, the representative configuration of the discharge roll 39 will be described later.

As shown in FIG. 5B, the recording material which is discharged by the discharge roll 39 is accommodated in the accommodating tray 10b. The discharge velocity of the discharge roll 39 is varied by a drive source (for example, drive motor) 41 which functions as the discharge velocity varying section, and the drive source 41 is controlled by a control device (for example, CPU) 50 which functions as the discharge velocity control section.

The control device 50 controls the drive source 41, and performs control such that the recording material is discharged at the velocity v1 which is predetermined by the drive source 41 when the second and subsequent recording materials are discharged and such that the recording material is discharged at the velocity v2 which is lower than the velocity v1 using the drive source 41 when the first recording material is discharged.

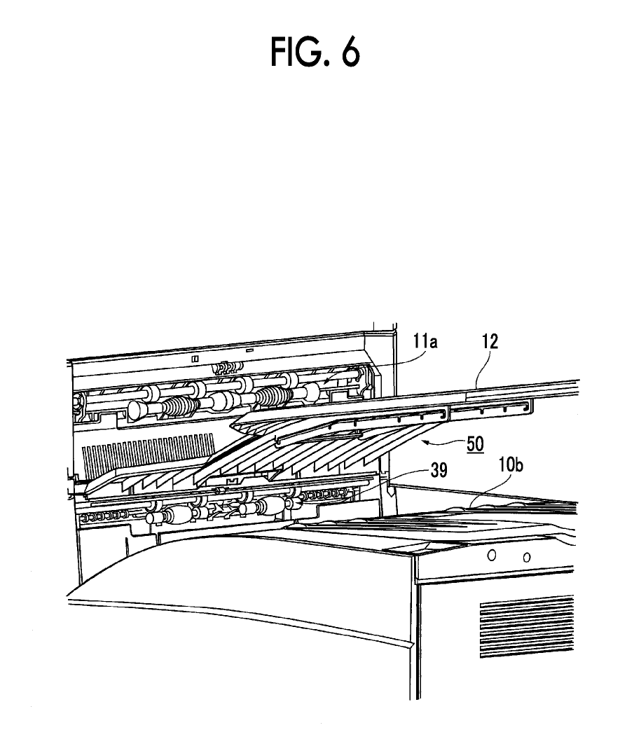

In addition, FIG. 6 is an enlarged diagram of FIG. 5A.

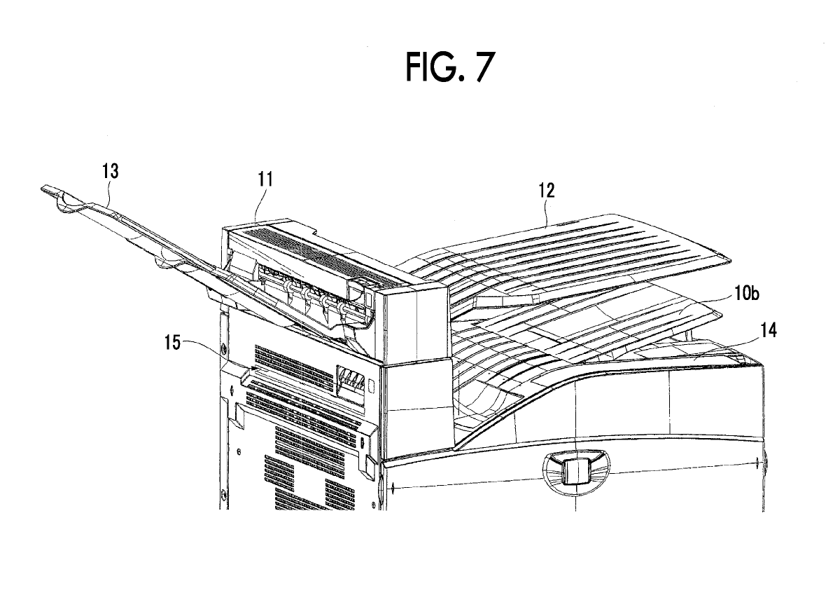

Further, FIG. 7 is a perspective diagram viewed from the side of another accommodating tray 13. An operation panel of the image forming device according to the exemplary embodiment is accommodated in reference numeral 14 in the drawing such that it is possible to designate the number of sheets for image formation or the accommodating tray and to perform operational input with regard to whether or not to perform offset discharge. In addition, reference numeral 15 indicates a discharge port through which the recording material on which the toner images are fixed is discharged. When, for example, a double-sided unit is attached between the discharge port and a delivery entrance, which is not shown in the drawing and is installed on the lower side of the discharge port 15, it is possible to reverse and transport the recording material having one side, on which the image formation is completed, without discharging the recording material to the accommodating tray, and it is possible to form an image on the back side thereof.

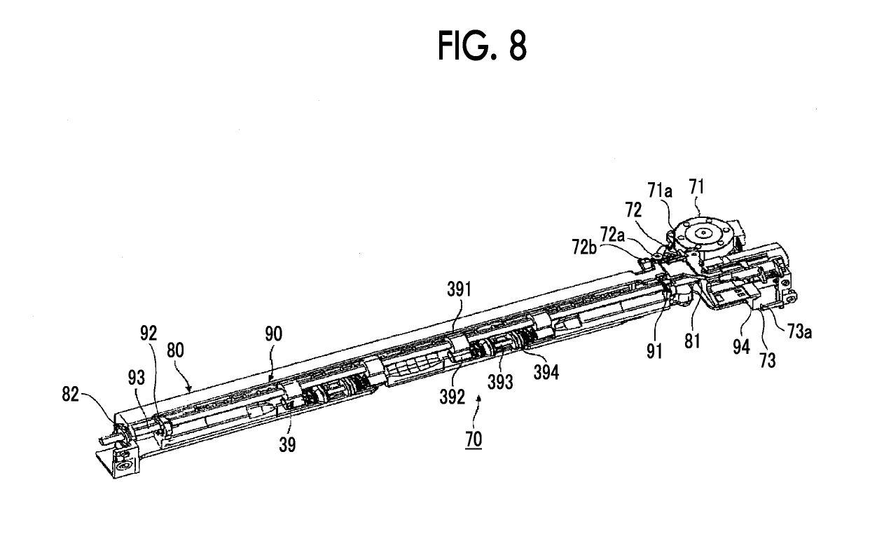

FIG. 8 is a perspective diagram illustrating the discharge roll 39 according to the exemplary embodiment.

The discharge roll 39 includes a drive roll 391 which is provided on a rotation shaft 93, and pinch rolls 392 which are driven to rotate according to the drive roll 391 while facing the drive roll 391. In addition, a corrugation roll 394, which is interposed between two pinch rolls 392 and projects to the side of the drive roll 391 in a portion in which the drive roll 391 is not installed, is provided on a rotation shaft 393 of the pinch rolls 392. The corrugation roll 394 reduces the bending of the recording material which is discharged by causing flapping to occur in the recording material which is discharged by the discharge roll 39, and thus excellent recording material discharge is performed. Further, in the exemplary embodiment, two sets of combinations of the two pinch rolls 392 and the corrugation roll 394 are provided. When the sets energize the frame of a movable-side chute 90 using an energizing section which is not shown in the drawing, the pinch rolls 392 are maintained to press the side of the drive roll 391.

In addition, in the exemplary embodiment, a displacement mechanism 70 is provided in the discharge roll 39 in order to perform offset discharge. The displacement mechanism 70 is divided into a fixing-side chute 80 which is fixed to the device main body 20 and the movable-side chute 90 which may move in the fixing-side chute 80.

The displacement mechanism 70 according to the exemplary embodiment includes an offset motor 71 which is provided integrally with the fixing-side chute 80, a sector gear 72 which fluctuates centering on a fluctuation fulcrum 72a according to the rotation of the offset motor 71, a drive gear 73 which drives the discharge roll 39, a belt which is not shown in the drawing and which transfers driving force to a belt reception part 73a of the drive gear 73 in addition to the fixing-side chute 80 and the movable-side chute 90.

The fixing-side chute 80 is provided with, for example, ball spline type bearings 81 and 82 at both ends thereof such that the rotation shaft 93, which will be described later, may slide therein.

In addition, the movable-side chute 90 is provided inside of the bearings 81 and 82 of the fixing-side chute 80 and is provided with radial type bearings 91 and 92 at both ends thereof. In the inner rings, the rotation shaft 93, which puts spin on the discharge roll 39, is provided to penetrate therethrough. The rotation shaft 93 is provided to penetrate the bearings 81 and 82 of the fixing-side chute 80 and the rotation shaft 93 moves according to the movement of the movable-side chute 90, thereby sliding in the bearings 81 and 82 of the fixing-side chute 80.

The rotation shaft 93 puts spin by the drive source (drive motor) 41 as the discharge velocity varying section. The drive source 41 is controlled by the control device 50 as the discharge velocity control section, and is capable of changing the discharge velocity v of the recording material.

Further, a transfer gear 94, which meshes with the drive gear 73 and maintains the meshing state with the drive gear 73 even when the rotation shaft 93 moves, is attached to one end of the rotation shaft 93 on a more outer side than the fixing-side chute 80.

In contrast, a gear 71a is attached to the offset motor 71, and the gear 71a meshes with a part of the sector gear 72. In addition, the sector gear 72 fluctuates between another end 72b of the sector gear 72 and the frame of the movable-side chute 90, and thus the movable-side chute 90 may move linearly.

Therefore, in the displacement mechanism 70 according to the exemplary embodiment, the sector gear 72 which meshes with the gear 71a of the offset motor 71, performs rotary movement centering on the fluctuation fulcrum 72a according to the rotation of the offset motor 71, and the rotary movement of the sector gear 72 causes the movable-side chute 90 to move.

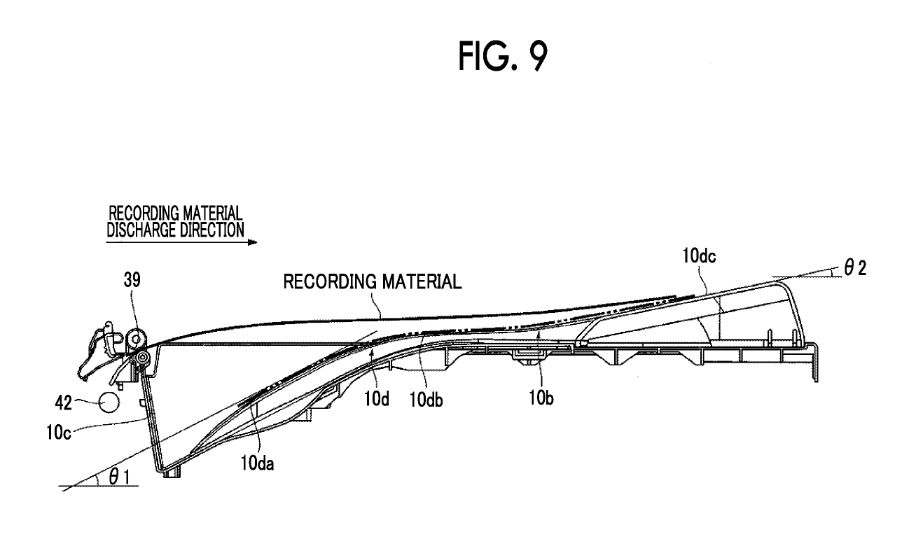

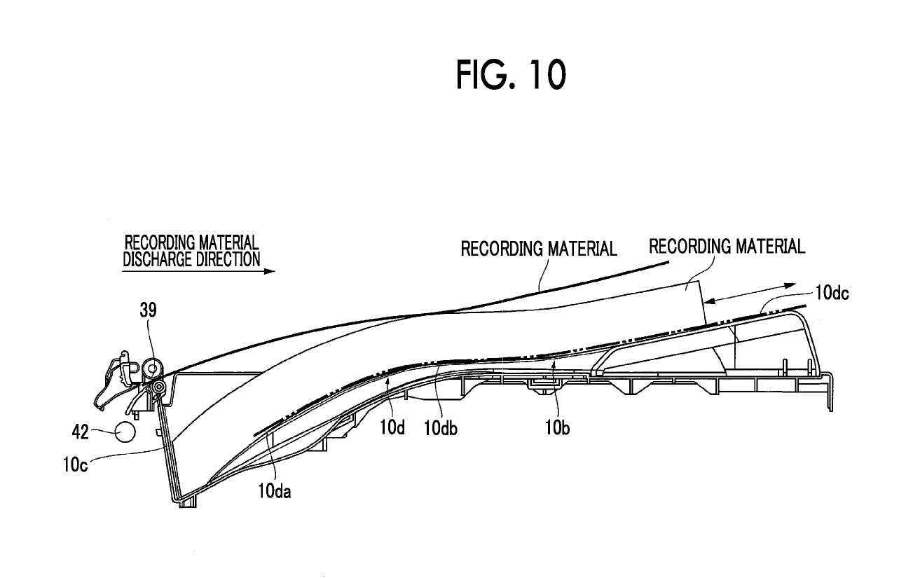

FIGS. 9 and 10 are schematic cross-sectional diagrams illustrating the vicinity of the accommodating tray 10b viewed from the front. FIG. 9 is a diagram illustrating a situation in which the first recording material is discharged, and FIG. 10 is a diagram illustrating a situation in which the second and subsequent recording materials are discharged.

In FIGS. 9 and 10, when the discharge roll 39 rotates, the recording material is discharged from the left side to the right side in the drawing. When the recording material is discharged by the discharge roll 39, the rear end position of the recording material is detected by a sensor 42 as the detection section, and the result of detection is notified to the control device 50. For example, a reflection-type optical sensor may be used as the sensor 42. When it is detected that light, which is radiated by an irradiation unit which is not shown in the drawing and is included in the sensor 42, is reflected in the recording material and then returns, it is recognized that the recording material is present in a sensor position. Thereafter, when light which is reflected in the recording material and then returns is not detected, it is detected that the recording material passes by that is, that the rear end position of the recording material is passed, and the result of detection is notified to the control device 50.

The sensor 42 is not limited to the reflection type, the irradiation unit is provided in a position facing the sensor 42 while interposing the recording material therebetween, and thus the presence of the recording material may be detected in such a way that light is shut out when the recording material is present between the sensor 42 and the irradiation unit. In addition, the sensor 42 is not limited to the optical sensor and it is possible to use various proximity sensors (induction type, capacitance type, ultrasonic type, electromagnetic wave type, infrared type, and the like).

A position in which the sensor 42 is arranged may be a position in which there is time to spare for the control device 50, which receives the notification of the result of detection of the rear end position acquired by the sensor 42, to perform control.

The accommodating tray 10b includes a positioning folded piece 10c which is bent and rises on the side of the discharge roll 39, and an accommodating plate 10d which loads and accommodates the recording material on the upper surface thereof. The discharged recording material falls on the left side in the drawing along the inclination of the accommodating plate 10d, comes into contact with the positioning folded piece 10c, and is positioned and accommodated.

The accommodating plate 10d includes a first inclined part 10da, a flat part 10db, and a second inclined part 10dc which have respectively different angles of inclination. The first inclined part 10da has an inclination of an angle θ1 which is horizontal when the side of the discharge roll 39 is lowered, the flat part 10db is substantially horizontal, and the second inclined part 10dc has an inclination of an angle θ2 which is horizontal when the side of the discharge roll 39 is lowered. The first inclined part 10da, the flat part 10db, and the second inclined part 10dc are provided such that steps are not made therebetween.

θ1 and θ2 are different angles, and the second inclined part 10dc has an inclination which is gentler than the first inclined part 10da. It is possible to set 01 to, for example, approximately 30 to 45° and to set 02 to, for example, approximately 15 to 25°. Due to the inclination of the second inclined part 10dc, the discharged second and subsequent recording materials also naturally fall toward the positioning folded piece 10c.

As shown in FIG. 9, when the discharged recording material is the first piece, the recording material directly comes into contact with the upper surface of the accommodating tray 10b. As shown in FIG. 10, when the discharged recording material is the second recording material or the subsequent recording material, the recording material comes into contact with the recording material which is already accommodated on the upper surface of the accommodating tray 10b. With regard to the coefficient of friction of the upper surface of the accommodating tray 10b and the coefficient of friction of the recording material, the coefficient of friction of the upper surface of the accommodating tray 10b is less than the coefficient of friction of the recording material. Therefore, when plural recording materials is discharged at the same discharge velocity, the first recording material easily slips rather than the second and subsequent recording materials, and thus the first recording material goes too far. Accordingly, there is a problem in that the accommodating tray for the recording material is dispersed. Here, in the exemplary embodiment, the dispersion of the accommodating tray for the recording material is corrected in such a way that the control device 50 performs control. Control performed by the control device 50 will be described below.

### First Aspect of Control Performed by Control Device 50

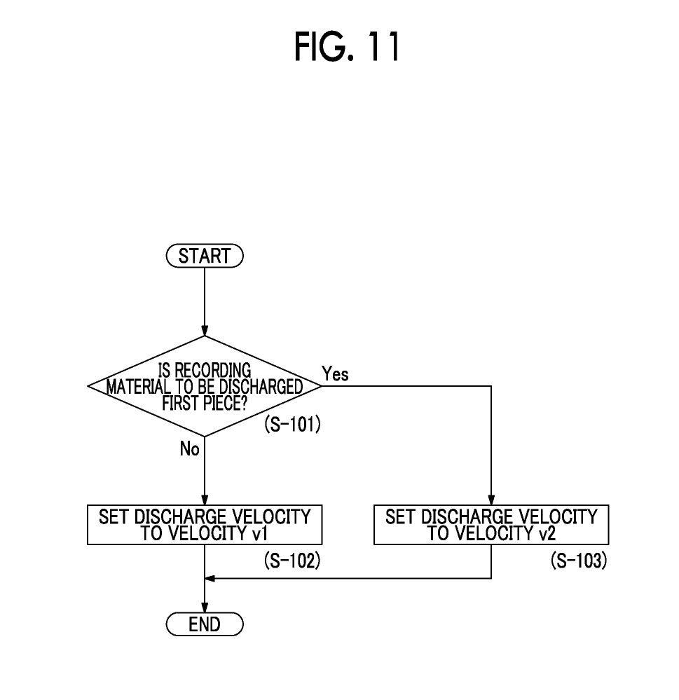

FIG. 11 is a flowchart illustrating a first aspect of control performed by the control device 50.

First, in step (S-101), it is determined whether or not a recording material, which is discharged at this time, is a first piece. The determination of whether or not the recording material is a first piece is, for example, determination of whether or not the recording material is a first piece of a series of discharge processes.

When it is determined that the recording material is not a first piece in step (S-101), the process proceeds to step (S-102), the discharge velocity is set to the velocity v1, and the process ends. The velocity v1 is, for example, a velocity which causes the recording material to be discharged at 180 mm/sec or higher (for example, 250 to 300 mm/sec).

When it is determined that the recording material is a first piece in step (S-101), the process proceeds to step (S-103), the discharge velocity is set to the velocity v2, and the process ends. The velocity v2 is a velocity which is lower than the velocity v1, and is, for example, a velocity which causes the recording material to be discharged under 180 mm/sec.

The discharge roll 39 is driven and the recording material is discharged based on the control performed by the control device 50.

### Second Aspect of Control Performed by Control Device 50

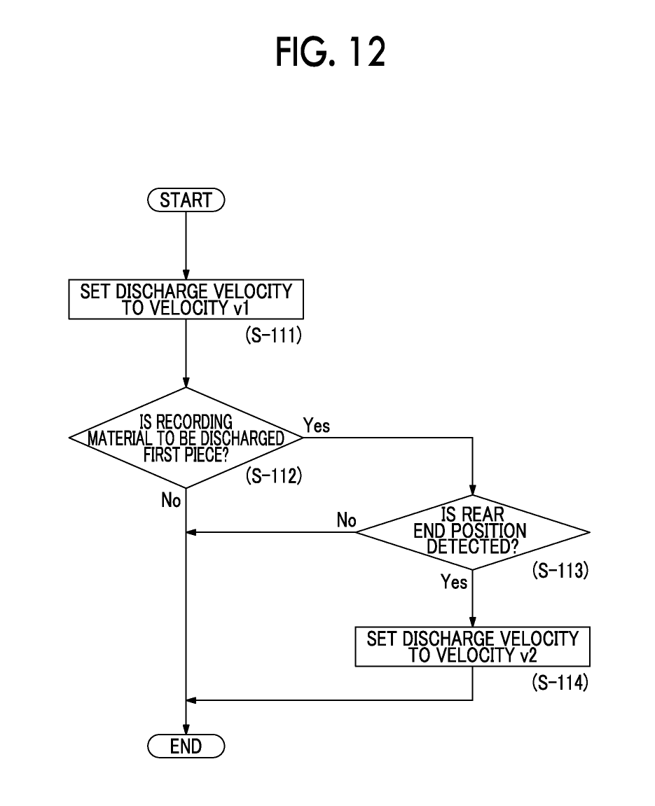

FIG. 12 is a flowchart illustrating a second aspect of control performed by the control device 50.

First, in step (S-111), the discharge velocity is set to the velocity v1. The velocity v1 is, for example, a velocity which causes the recording material to be discharged at 180 mm/sec or higher (for example, 250 to 300 mm/sec).

Subsequently, in step (S-112), it is determined whether or not a recording material, which is discharged at this time, is a first piece. The determination of whether or not the recording material is a first piece is, for example, determination of whether or not the recording material is a first piece of a series of discharge processes.

When it is determined that the recording material is not a first piece in step (S-112), the process ends without change.

When it is determined that the recording material is a first piece in step (S-112), the process proceeds to step (S-113), and it is determined whether or not the rear end position of the recording material is detected by the sensor 42.

When it is determined that the rear end position is not detected in step (S-113), the process ends without change.

When it is determined that the rear end position is detected in step (S-113), the discharge velocity is set to the velocity v2 and the process ends. The velocity v2 is a velocity which is lower than the velocity v1 and is, for example, a velocity which causes the recording material to be discharged under 180 mm/sec.

The discharge roll 39 is driven and the recording material is discharged based on the control performed by the control device 50. According to the aspect, the rear end position of the recording material is detected. Therefore, when the first recording material is discharged, the discharge velocity is changed from the velocity v1 to the velocity v2 immediately before the recording material slips out from the discharge roll 39. That is, the transport itself of the recording material is performed at the velocity v1 and discharge is performed at the velocity v2 immediately before the recording material is discharged, and thus deviation in the accommodating tray of the discharged recording material is not generated and it is possible to reduce time taken for discharge.

### Second Exemplary Embodiment

### Whole Configuration

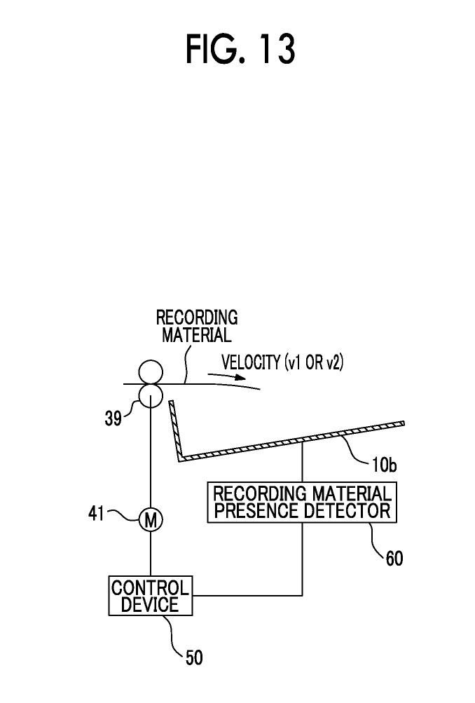

Since the whole configuration according to a second exemplary embodiment is the same as the whole configuration according to the first exemplary embodiment which has been described with reference to FIGS. 3 to 10, the detailed description thereof will not be repeated and the difference therebetween will be described with reference to FIG. 13 while referring to the configuration of FIGS. 3 to 10.

FIG. 13 is a schematic block diagram illustrating a configuration in which the discharge roll 39 discharges a recording material in an image forming device according to the second exemplary embodiment.

As shown in FIG. 13, the recording material which is discharged by the discharge roll 39 is accommodated in the accommodating tray 10b. The discharge velocity of the discharge roll 39 is varied by the drive source (for example, drive motor) 41 which functions as the discharge velocity varying section, and the drive source 41 is controlled by the control device (for example, CPU) 50 which functions as the discharge velocity control section.

The control device 50 controls the drive source 41 and selects any one of at least two types of velocities in cases in which the recording material is discharged at the velocity v1 and discharged at the velocity v2.

The presence of the recording material which is accommodated in the accommodating tray 10b as the recording material accommodating unit is detected by a recording material presence detector 60 as the recording material presence determination section, the control device 50 performs control such that the recording material is discharged at the velocity v1 which is predetermined by the drive source 41 when it is determined that there is a recording material which is accommodated in the accommodating tray 10b and such that the recording material is discharged at the velocity v2 which is lower than the velocity v1 using the drive source 41 when it is determined that there is not a recording material which is accommodated in the accommodating tray 10b.

### Aspect of Recording Material Presence Detector 60

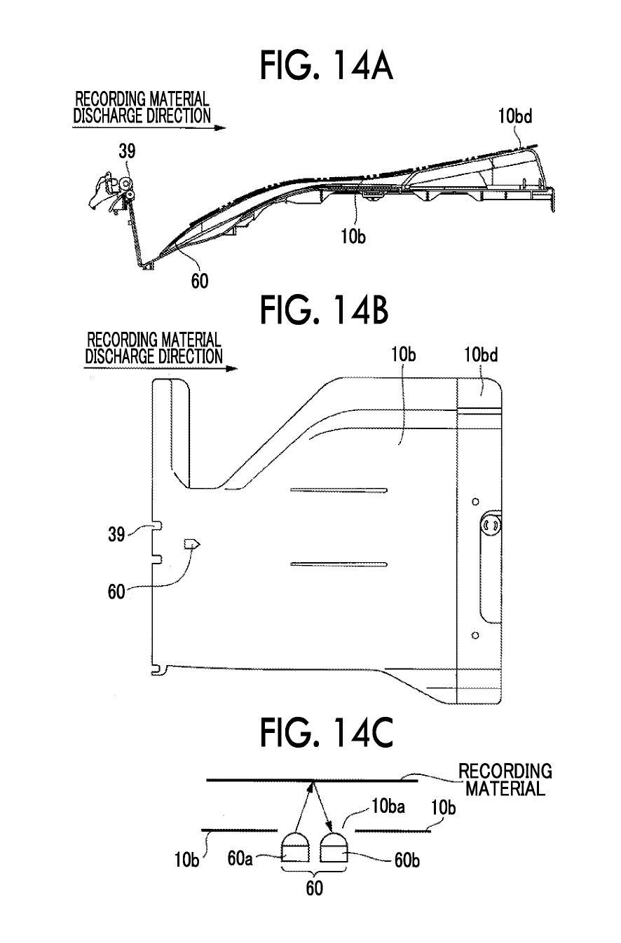

FIGS. 14A to 14C are views illustrating the recording material presence detector 60. FIG. 14A is a front view in which the vicinity of the accommodating tray 10b is viewed from the front of FIG. 3, FIG. 14B is a plan view in which the accommodating tray 10b of FIG. 14A is viewed from the upper side upper side, and FIG. 14C is a schematic diagram illustrating an example of the configuration of the recording material presence detector 60.

In FIGS. 14A and 14B, when the discharge roll 39 is rotated, the recording material is discharged from the left side to the right side in the drawing. The recording material presence detector 60 as the recording material presence determination section is provided on the side of the discharge roll 39 on the upper surface (the loading surface of the recording material) of the accommodating tray 10b.

As shown in FIG. 14C, a through hole 10ba is provided on the upper surface of the accommodating tray 10b such that light of the recording material presence detector 60 passes therethrough. Instead of the through hole 10ba, a transparent member may be used such that light of the recording material presence detector 60 may be transmitted. The recording material presence detector 60 includes an irradiation unit 60a which irradiates the upper side with light, detects light using a detection unit 60b when the light reflects in the recording material which is accommodated in the accommodating tray 10b and returns thereto, and then determines that the recording material which is accommodated in the accommodating tray 10b is present. When light which is radiated by the irradiation unit 60a does not return and it is difficult to detect the light using the detection unit 60b, the recording material presence detector 60 determines that the recording material which is accommodated in the accommodating tray 10b is not present. The result of determination is notified to the control device 50.

The recording material presence detector 60 is not limited to the reflection type. The irradiation unit 60a may be provided in a position which faces the recording material presence detector 60 while interposing the recording material therebetween, and may detects the presence of the recording material in such a way that light is shut out when the recording material is present between the recording material presence detector 60 and the irradiation unit 60a. In addition, the recording material presence detector 60 is not limited to the optical sensor and it is possible to use various proximity sensors (induction type, capacitance type, ultrasonic type, electromagnetic wave type, infrared type, and the like).

Also, in FIG. 14A, the reference numeral 10bd indicates a recording material presence/non-presence display lamp which lights, for example, when the recording material is present based on the result of detection of the recording material presence detector 60.

### Third Aspect of Control Performed by Control Device 50

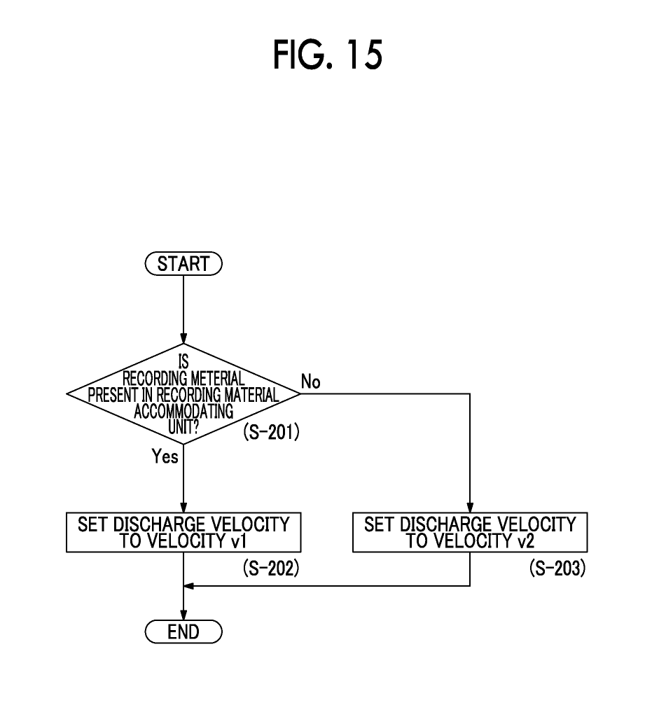

FIG. 15 is a flowchart illustrating a third aspect of control performed by the control device 50.

First, in step (S-201), it is determined whether or not the recording material is present in the accommodating tray 10b (corresponding to the recording material accommodating unit). The determination is made based on the result of determination performed by the recording material presence detector 60 (corresponding to the recording material presence determination section).

When it is determined that the recording material is present in step (S-201), the process proceeds to step (S-202), the discharge velocity is set to the velocity v1, and the process ends. The velocity v1 is, for example, a velocity which causes the recording material to be discharged at 180 mm/sec or higher (for example, 250 to 300 mm/sec).

When it is determined that the recording material is not present in step (S-201), the process proceeds to step (S-203), the discharge velocity is set to the velocity v2, and the process ends. The velocity v2 is a velocity which is lower than the velocity v1, and is, for example, a velocity which causes the recording material to be discharged under 180 mm/sec.

The discharge roll 39 is driven and the recording material is discharged based on the control performed by the control device 50.

### Fourth Aspect of Control Performed by Control Device 50

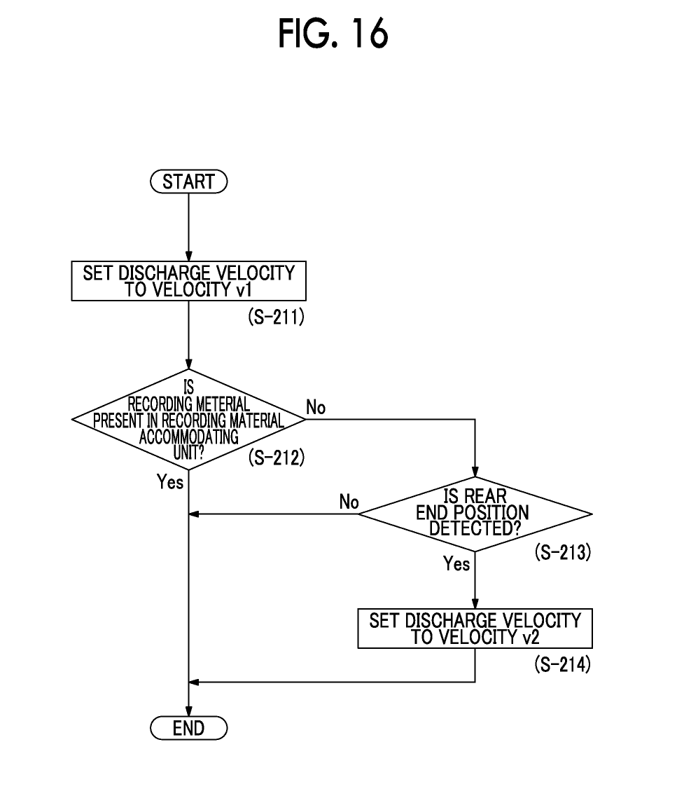

FIG. 16 is a flowchart illustrating a fourth aspect of control performed by the control device 50.

First, in step (S-211), the discharge velocity is set to the velocity v1. The velocity v1 is, for example, a velocity which causes the recording material to be discharged at 180 mm/sec or higher (for example, 250 to 300 mm/sec).

Subsequently, in step (S-212), it is determined whether or not the recording material is present in the accommodating tray 10b (corresponding to the recording material accommodating unit). The determination is made based on the result of determination performed by the recording material presence detector 60 (corresponding to the recording material presence determination section).

When it is determined that the recording material is present in step (S-212), the process ends without change.

When it is determined that the recording material is not present in step (S-212), the process proceeds to step (S-213), and it is determined whether or not the rear end position of the recording material is detected by the sensor 42.

When it is determined that the rear end position is not detected in step (S-213), the process ends without change.

When it is determined that the rear end position is detected in step (S-213), the discharge velocity is set to the velocity v2, and the process ends. The velocity v2 is a velocity which is lower than the velocity v1, and is, for example, a velocity which causes the recording material to be discharged under 180 mm/sec.

The discharge roll 39 is driven and the recording material is discharged based on the control performed by the control device 50. According to the aspect, the rear end position of the recording material is detected. Therefore, when the first recording material is discharged, the discharge velocity is changed from the velocity v1 to the velocity v2 when the recording material slips out from the discharge roll 39, the transport of the recording material itself is performed at the velocity v1, discharge is performed at the velocity v2 at a moment that the recording material is discharged, and thus deviation in the accommodating tray of the discharged recording material is not generated and it is possible to reduce time taken for discharge.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording material discharge device comprising:
a recording material discharge member that discharges recording materials; and
a recording material accommodating unit that accommodates the plurality of recording materials which are discharged from the recording material discharge member,
wherein a discharge velocity of a first recording material discharged by the recording material discharge member is lower than a discharge velocity of each of second and subsequent recording materials.

2. A recording material discharge device comprising:
a recording material discharge member that discharges recording materials;
a recording material accommodating unit that accommodates the plurality of recording materials which are discharged from the recording material discharge member;
a discharge velocity varying section that changes a discharge velocity of each of the recording materials discharged by the recording material discharge member; and
a discharge velocity control section that performs control such that the recording materials are discharged at a velocity which is predetermined by the discharge velocity varying section when second and subsequent recording materials are discharged and such that the recording materials are discharged at a velocity which is lower than the velocity by the discharge velocity varying section when a first recording material is discharged.

3. A recording material discharge device comprising:
a recording material discharge member that discharges recording materials; and
a recording material accommodating unit that accommodates the recording materials which are discharged from the recording material discharge member,
wherein, in a case in which there is no recording material which is accommodated in the recording material accommodating unit, a discharge velocity of each of the recording materials discharged by the recording material discharge member is caused to be low compared to a case in which there is the recording material which is accommodated in the recording material accommodating unit.

4. A recording material discharge device comprising:
a recording material discharge member that discharges recording materials;
a recording material accommodating unit that accommodates the recording materials which are discharged from the recording material discharge member;
a discharge velocity varying section that changes a discharge velocity of each of the recording materials discharged by the recording material discharge member;
a recording material presence determination section that determines the presence of the recording materials which are accommodated in the recording material accommodating unit; and
a discharge velocity control section that performs control such that the recording materials are discharged at a velocity which is predetermined by the discharge velocity varying section when it is determined that there is a recording material which is accommodated in the recording material accommodating unit by the recording material presence determination section and such that the recording materials are discharged at a velocity which is lower than the velocity by the discharge velocity varying section when it is determined that there is no recording material which is accommodated in the recording material accommodating unit.

5. The recording material discharge device according to claim 1,
wherein the recording material discharge member has a velocity which is equal to or higher than 180 mm/sec and a velocity which is lower than 180 mm/sec as the discharge velocity of each of the recording materials.

6. The recording material discharge device according to claim 2,
wherein the recording material discharge member has a velocity which is equal to or higher than 180 mm/sec and a velocity which is lower than 180 mm/sec as the discharge velocity of each of the recording materials.

7. The recording material discharge device according to claim 3,
wherein the recording material discharge member has a velocity which is equal to or higher than 180 mm/sec and a velocity which is lower than 180 mm/sec as the discharge velocity of each of the recording materials.

8. The recording material discharge device according to claim 4,
wherein the recording material discharge member has a velocity which is equal to or higher than 180 mm/sec and a velocity which is lower than 180 mm/sec as the discharge velocity of each of the recording materials.

9. The recording material discharge device according to claim 1,
wherein the recording material discharge member causes the discharge velocity of each of the recording materials to be low while the first recording material is discharged.

10. The recording material discharge device according to claim 2,
wherein the recording material discharge member causes the discharge velocity of each of the recording materials to be low while the first recording material is discharged.

11. The recording material discharge device according to claim 9,
wherein the recording material discharge member causes the discharge velocity of each of the recording materials to be low immediately before a rear end position of the first recording material slips out from the recording material discharge member.

12. The recording material discharge device according to claim 10,
wherein the recording material discharge member causes the discharge velocity of each of the recording materials to be low immediately before a rear end position of the first recording material slips out from the recording material discharge member.

13. The recording material discharge device according to claim 3,
wherein the recording material discharge member causes the discharge velocity of each of the recording materials to be low while the recording materials are discharged when there is no recording material which is accommodated in the recording material accommodating unit.

14. The recording material discharge device according to claim 4,
wherein the recording material discharge member causes the discharge velocity of each of the recording materials to be low while the recording materials are discharged when there is no recording material which is accommodated in the recording material accommodating unit.

15. The recording material discharge device according to claim 13,
wherein the recording material discharge member causes the discharge velocity of each of the recording materials to be low immediately before a rear end position of the recording material slips out from the recording material discharge member when there is no recording material which is accommodated in the recording material accommodating unit.

16. The recording material discharge device according to claim 14,
wherein the recording material discharge member causes the discharge velocity of each of the recording materials to be low immediately before a rear end position of the recording material slips out from the recording material discharge member when there is no recording material which is accommodated in the recording material accommodating unit.

17. A recording material processing device comprising:
a processing unit that processes recording materials; and
the recording material discharge device according to claim 1.
